(19) United States
(12) Patent Application Publication
(10) Pub. No.: US 2012/0311037 A1
(43) Pub. Date: Dec. 6, 2012

(54) Method and System for Collective Socializing Using A Mobile Social Network

(76) Inventors: Suthaharan Sivasubramaniam, San Carlos, CA (US); Kirubaharan Sivasubramaniam, Cliffton Park, NY (US)

(21) Appl. No.: 13/296,076

(22) Filed: Nov. 14, 2011

Related U.S. Application Data
(63) Continuation of application No. 12/031,467, filed on Feb. 14, 2008, now abandoned.

(51) Int. Cl. G06F 15/16

(52) U.S. Cl. 709/204

(57) ABSTRACT

A method for collective socializing using a mobile social network, which includes obtaining collective socializing data on at least one location, and transmitting the collective socializing data upon request of at least one user. In addition, the step of obtaining collective socializing data on at least one locations further includes storing the collective socializing data on the at least one location on a system server, obtaining additional collective socializing data from a plurality of users on the at least one location; and combining the additional collective socializing data with the collective socializing data on the system server for transmittal to the at least one user upon request.

### RELATED APPLICATION

This application claims priority as a continuation application under 35 U.S.C. §120 to U.S. patent application Ser. No. 12/031,467, filed Feb. 14, 2008. The entire contents of this application is hereby incorporated by reference in its entirety.

### FIELD OF THE INVENTION

This invention generally relates to how people identify locations of interest to visit and spend time, and more particularly, to a system that utilizes the location of any device of communication used and carried by individuals, including mobile phones, personal digital assistants or other handheld devices to transmit collective socializing data for a location to the communication device (i.e., a mobile client device) based on the location of the communication device via a network connection.

### BACKGROUND

Existing online social networking sites and bulletin boards can be used to recommend a location as a point of interest. These places can then be suggested to a user as local businesses, either based on their current location by using a GPS (Global Positioning System) on their handheld mobile communication device or getting them to enter an address. This mode of recommendation has many shortcomings. For example, a café that is fun (i.e., busy or fun to be at) on a Saturday evening can be deserted on a Tuesday evening or even closed because of a local holiday; also recommendations placed on online bulletin boards for a restaurant can be outdated. Alternatively, an event that is not a business such as a parade or a street concert would not even be suggested, making current recommendation models ineffective.

Thus, what is needed is a system that identifies where people are currently gathered and offer this information to motivate a user to be part of the gathering or congregation. In addition, it would be desirable to a system, which provides real-time or near real-time recommendations from people who are currently at a location and/or business to offer incentives to encourage users to find their way to the location and/or business.

### SUMMARY

In accordance with one embodiment, a method for collective socializing using a mobile social network comprises: obtaining collective socializing data on at least one location; and transmitting the collective socializing data upon request of at least one user. In addition, the step of obtaining collective socializing data on at least one locations further comprises: storing the collective socializing data on the at least one location on a system server; obtaining additional collective socializing data from a plurality of users on the at least one location; and combining the additional collective socializing data with the collective socializing data on the system server for transmittal to the at least one user upon request.

In accordance with another embodiment, a method for collective socializing using a mobile social network comprises: storing collective socializing data for a plurality of locations on a server system; obtaining additional collective socializing data from a plurality of users, wherein the additional collective socializing data further comprises transmitting a location of the at least one mobile client device to the system server; identifying each of the plurality of users with a unique identifier, wherein the unique identifiers for each of the plurality of users identifies the user's personal profile; combining the addition collective socializing data with the collective socializing data on the system server; obtaining a request from a user for collective socializing data from the server system; providing the collective socializing data to the user based on the user's personal profile; and transmitting collective socializing data to a user via a mobile client device.

In accordance with a further embodiment, a system for collective socializing using a mobile social network comprises: a system server for managing a collective socializing application for a plurality of locations; and one or more mobile client devices, which receive collective socializing application from the system server for a location based on the location of the mobile client device via a network.

### BRIEF DESCRIPTION OF THE DRAWINGS

In the following, exemplary embodiments will be explained in greater detail in reference to drawings, wherein:

FIG. 1A is a schematic diagram of a system for collective socializing using a mobile social network in accordance with an embodiment.

FIG. 1B is a schematic diagram of a system for collective socializing using a mobile social network in accordance with another embodiment.

FIG. 2A is a block diagram illustrating a method of use of a system for collective socializing using a mobile social network in accordance with an embodiment.

FIG. 2B is a block diagram illustrating a method of use of a system for collective socializing using a mobile network in accordance with another embodiment.

FIG. 3 is a block diagram illustrating a method of use of a system for collective socializing using a mobile network in accordance with a further embodiment.

FIG. 4A is a schematic diagram of a system for collective socializing using a mobile social network in accordance with an embodiment.

FIG. 4B is a schematic diagram of a system for collective socializing using a mobile social network in accordance with another embodiment.

FIGS. 5A-5G are screen shots of a mobile client device in the form of a personal digital assistant (PDA) showing the use of a system or method for collective socializing using a mobile social network in accordance with another embodiment.

### DETAILED DESCRIPTION

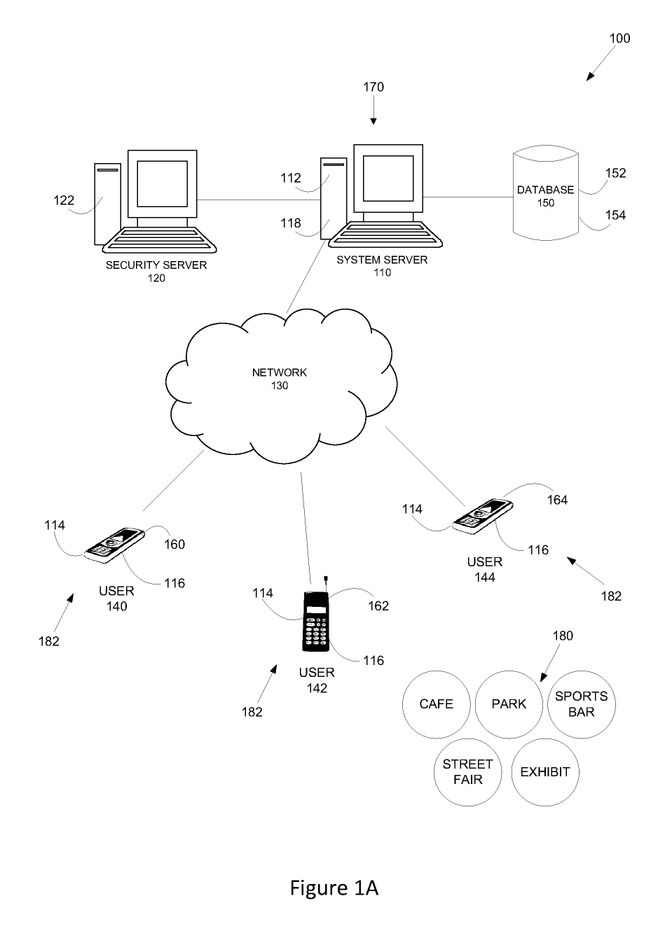

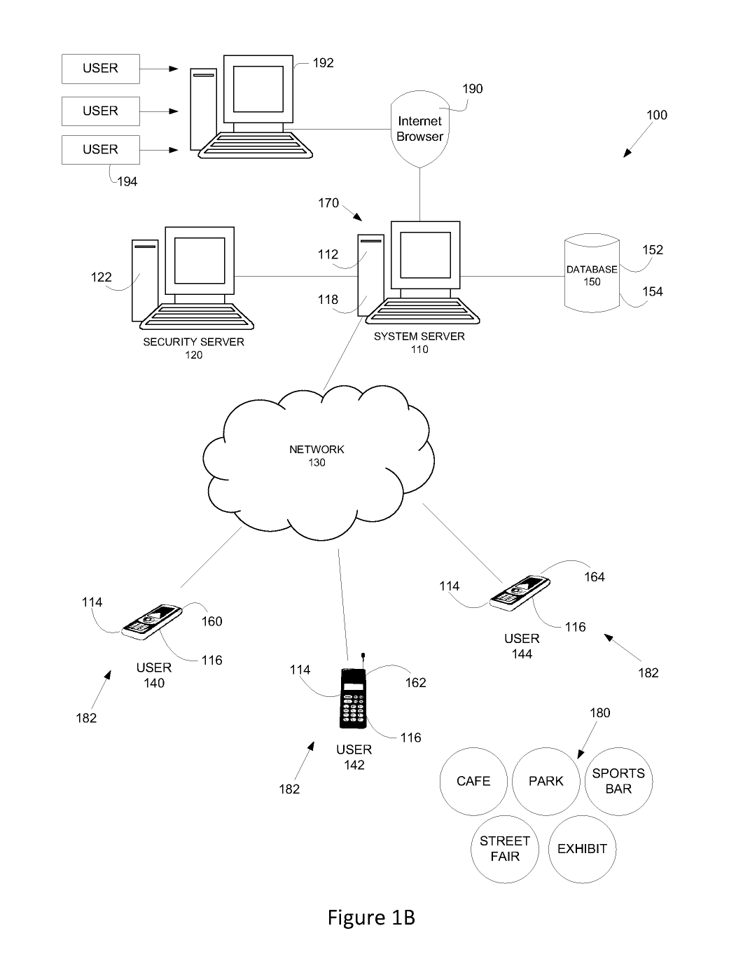

FIG. 1A is a schematic diagram of a system 100 for collective socializing using a mobile social network in accordance with an exemplary embodiment. As shown in FIG. 1A, the system 100 preferably includes a system server 110 (server), a mobile social network (or network or network connection) 130 and one or more mobile client devices 160, 162, 164 (client), which communicate with the system server 110 via the mobile social network 130 (i.e., a network or a network connection). In accordance with an exemplary embodiment, the system server 100 manages a collective socializing application 118 for a plurality of locations 180. The one or more mobile client devices 160, 162, 164 receive the collective socializing application 118 from the system server 110 for a location based on the location 182 of the mobile client device 160, 162, 164 via the network 130.

In accordance with an exemplary embodiment, the system server 110 can be configured to obtain a request from a user 140, 142, 144 for collective socializing data 152. The system server 110 provides the collective socializing data 112 to the user 140, 142, 144 based on a personal profile 154 of the user 140, 142, 144 requesting the collective socializing data 152. Each of the plurality of users 140, 142, 144 has a unique identifier 116, which identifies the user's personal profile 154. In accordance with an embodiment, the system server 110 obtains additional collective socializing data 112 from a plurality of users 140, 12, 144, combines the additional collective socializing data 112 with the collective socializing data 112 on the system server 110, and transmits the collective socializing data 112 to at least one mobile client device 160, 162, 164. The additional collective socializing data 112 further comprises transmitting a location of the at least one mobile client device 160, 162, 164 to the system server 110. In accordance with an embodiment, the at least one mobile client device 160, 162 164 periodically transmits the location of the mobile client device 160, 162, 164 to the system server 110.

The system 100 can also include a security server 120, which encrypts and decrypts the collective socializing data 112 transmitted to and from the mobile client device 160, 162, 164. The system server 110 also is configured to filter the personal profile 154 of each of the users 140, 142, 144 into groups or subgroups of users 140, 142, 144 having similar personal profiles 154. For example, a high concentration of users 140, 142, 144 can be identified from the transmission of the locations 182 of a plurality of mobile client devices 160, 162, 164 over a defined period of time, wherein the defined period of time can be from seconds (e.g. 1 second) to hours or even days. For example, a sudden decrease in mobile client devices 160, 162, 164 transmitting from a single location 182 (or locale) can be used by the system 100 as a security tool to trigger an alert if there is a mass dispersion of users 140, 142, 144 from a particular location 180 occurs within a short period of time.

The system server 110 receives the location of the mobile client device 160 and based on the personal interest or profile of the user 140 associated with the mobile client device 160, 162, 164, an aggregation of related interest in the vicinity of the mobile client device 160 is communicated to the mobile client device 160, 162, 164 upon request. It can be appreciated that users 140, 142, 144 of the system 100 do not need to be a registered user to obtain social collective data 112 from the system 100. In addition, the user 140, 142, 144 does not need to be a subscriber to the collective social provider or service 170. For example, in accordance with an exemplary embodiment, a subscriber pays a monthly and/or annual fee to the collective social provider or service 170. The collective social provider or service 170 is preferably a single or group of providers who have gathered the collective socializing data 112 for transmission to a plurality of users 140, 142, 144.

In accordance with an exemplary embodiment, the system server 110 manages a collective socializing application 118 having collective socializing data 112, which includes social and personal data on a plurality of user's locations 180 of interest, including locations 180 of interest to visit and/or spend time. The collective socializing data 112 preferably includes businesses and/or locations 180 such as restaurant, bars and/or sports bars, nightclubs, cafés, live music venues, art exhibit or fair, art galleries or studios, or event (non business type event) such as a parade, a basketball court, an intersection or street, a street fair, a park, a concert, or other suitable type of gathering or congregation of people.

For example, an interested subscriber will download and install the system software 114 to the mobile client device 160, 162, 164. In accordance with an exemplary embodiment, registration with the system 100 is performed using a unique identifier 116, which is associated with a specific user 140, 142, 144 and/or a mobile client device 160, 162, 164. In accordance with an embodiment, the unique identifier 116 can be a phone number, an email address, a device ID of the mobile client device or a profile or personal profile user name.

In accordance with an exemplary embodiment, the user 140, 142, 144 can set personal interests (i.e., a personal profile 154) such as tennis, dancing or horse back riding using the system software 114. These interests (or personal profile 154) are then communicated to the system server 110 and stored in the context of the unique identifier 116. These personal interests and/or personal profiles 154 will also be used to suggest locations where other users with similar interests are congregating. In accordance with an exemplary embodiment, a user 140 (or subscriber) can setup a personal profile name or identifier, which can be associated with the unique identifier 116.

The system server 110 is associated with a plurality of users 140, 142, 144, which communicates (via a transmission of a data) with the system server 110 via the mobile social network or network connection 130. In accordance with an exemplary embodiment, each of the plurality of users 140, 142, 144, uses a mobile client device 160, 162, 164 to communicate with the system server 110, including the location of the user 140, 142, 144 via the mobile client device 160, 162, 164 and other related interest and/or social data and/or collective socializing data 112. The plurality of users 140, 142, 144 can be registered users and/or subscribers with a collective socializing provider 170. Alternatively, the users 140, 142, 144 are not required to be register and/or subscribers with the collective socializing provider 170.

In accordance with an exemplary embodiment, the client devices 160, 162, 164 include a system software 114 (or program), which the client devices 160, 162, 164 downloads from the system server 110, a client device readable medium or other suitable system or medium, which can provide the system software 114 to the client device 160. Alternatively, the client device 160 can be manufactured and sold or delivered to the user 140 with the system software 114 preloaded or installed on the client device 160. In accordance with an exemplary embodiment, the downloaded client software 114 will identify the current location of the device 160, 162, 164 and communicate this information to the system server 110 at periodic intervals. It can be appreciated that the gathering of the location 182 (or locals) of the mobile client devices 160, 162, 164 can be from an individual program on the mobile client devices 160, 162, 164 or aggregated from service providers.

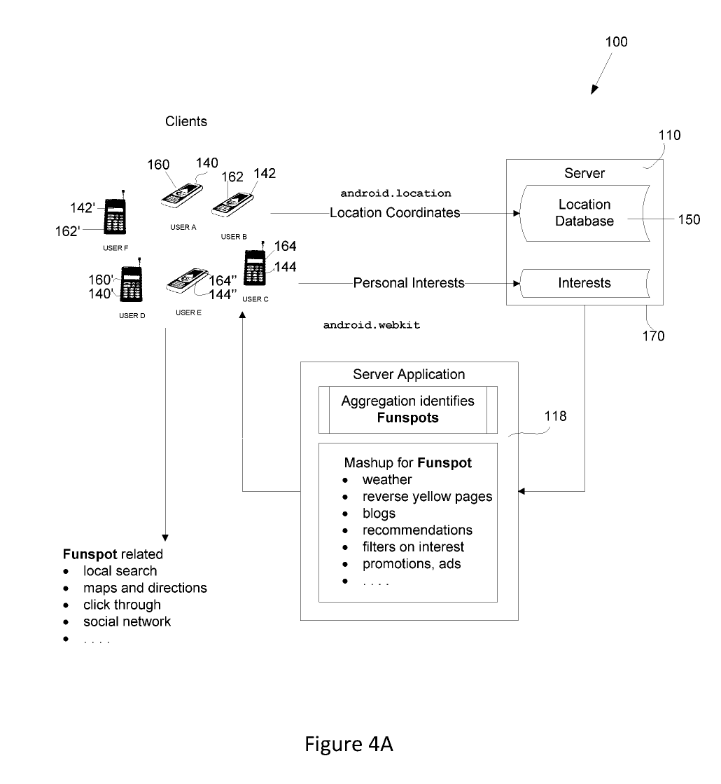

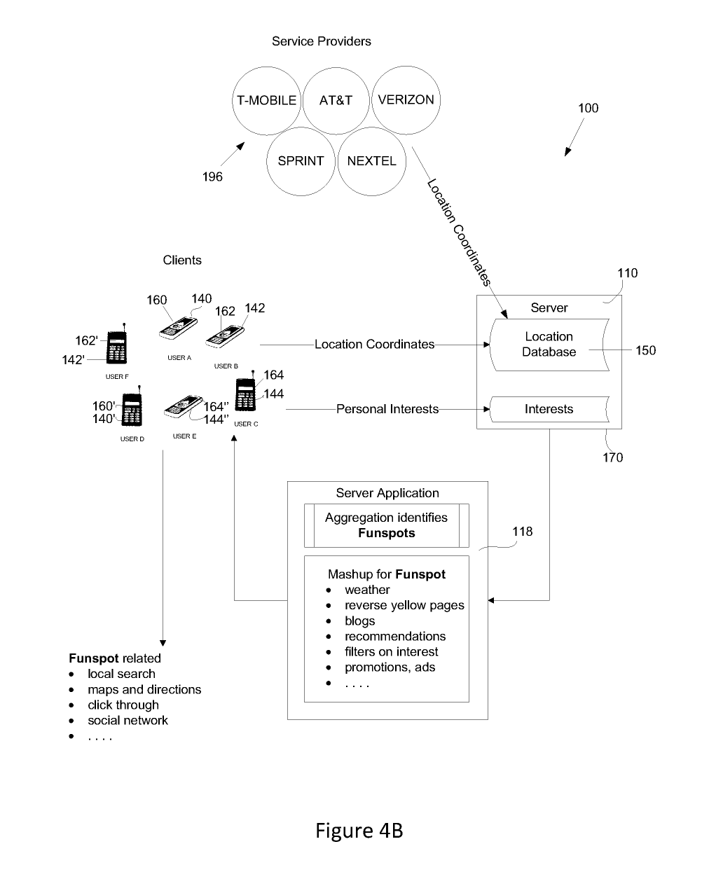

In accordance with an exemplary embodiment, the mobile client device 160 is preferably a personal digital assistant (PDAs) such as a handheld computer, a small computer or a palmtop computer. In accordance with an embodiment, the mobile client device 160 and/or personal digital assistant (PDA) includes access to a mobile network, network or network connection 130 in the form of the Internet, intranets or extranets via a cellular signal or frequency, a Wi-Fi signal (or Hotspots), a Wireless Wide-Area Networks (WWANs) or any medium that facilitates the transfer of data from the client software 114 contained within the mobile client device 160, 162, 164 to the system server 110 and vice versa. It can be appreciated that in accordance with an exemplary embodiment, the system 100 is usable by all wireless users regardless of their service provider. In addition, it can be appreciated that the system 100 can be usable by all wireless users regardless of their cellular service provider 196 (FIG. 4B) (e.g. AT&T®, Verizon®, T-Mobile®, etc.) and/or wireless internet provider.

In accordance with an exemplary embodiment, the location of the mobile client device 160, 162, 164 (and the user 140, 142, 144 associated with the client mobile device 160, 162, 164) can be gathered from the system software on the mobile device 160, 162, 164 or aggregated from the service provider. For example, the location of users 140, 142, 144 can be gathered from the system software 114 on the mobile client devices 160, 162, 164 or aggregated from the wireless internet service provider and/or providers. Alternatively, location information can be retrieved using a GPS (Global Positioning System) unit on the mobile client device 160, 162, 164, or alternatively an algorithm such as GPS triangulation, Peer-to-Peer Wireless Positioning, and/or any suitable mode of Virtual GPS. Location 182 information can also be gathered from connections from the devices 160, 162, 164 to Wi-Fi spots whose physical locations are already known. In accordance with an alternative embodiment, the user 140, 142, 144 can manually enter the location (or locale) information 182 of the mobile client device 160, 162, 164 into the system 100 manually. It can be appreciated that the location (or locale) information 182 gathered from the users 140, 142, 144 can be in the context of a specific user 140, 142, 144 with an associated unique identifier 116 or anonymously.

In accordance with another exemplary embodiment, the system 100 includes a database 150 for storing collective socializing data 152. The database 150 is preferably configured to store unique identifiers 116 for a plurality of users 140, 142, 144, their interests including the user's 140, 142, 144 personal profile 154, and the mobile client device's 160, 162, 164 latest location or locale 182 as communicated to the database 150. In accordance with an embodiment, the latest location or locale 182 is transmitted or communicated from the client software 114 that is installed on the individual user mobile client devices 160, 162, 164 to the system server 110.

In accordance with an exemplary embodiment, the system 100 can also include a security server 120, which is responsible for encrypting and decrypting information coming from the individual client software 114, including personal profiles 154 (and/or interest related to a specific user 140, 142, 144) and the location of the mobile client device 160, 162, 164.

Alternatively, in accordance with another exemplary embodiment, the system 100 can be used in a non-anonymous fashion, wherein the user's 140, 142, 144 personal profile 154 and/or identity is published to a limited group of users 140, 142, 144 and/or all registered users, subscribers and/or non registered user's based on the user's 140, 142, 144 personal profile 154 and decision on whom may see the user's 140, 142, 144 personal profile 154. For example, a user's 140, 142, 144 anonymity can either be an opt-in or opt-out.

In accordance with another exemplary embodiment, a subscriber's personal interests and/or personal profile 154 can be used as a filter for user's 140, 142, 144 having similar interests and as a means or resource to evaluate the user's 140, 142, 144 input and/or comments on desirable and non-desirable locations and/or businesses. For example, a filter can be implemented based on groups and networks or other forms of social association. It can be appreciated that these groups or networks can be public or private. In addition, a subscriber's interest may be stored on the server 110, or can be stored on the mobile client device 160, 162, 164 to address concerns of sharing private information with strangers and/or a potentially unsecured source.

FIG. 1B is a schematic diagram of a system 100 for collective socializing using a mobile social network in accordance with another embodiment. As shown in FIG. 1B, the system 100 includes a system server 110 (server), a mobile social network (or network or network connection) 130, one or more mobile client devices 160, 162, 164 (client), which communicate with the system server 110 via the mobile social network 130 (i.e., a network or a network connection), and an internet or web browser 190 having one or more client devices 192 associated therewith, which enables at least one user 194 to obtain collective socializing data 154 from the system server 110. The one or more client devices 192 allow the at least one user 194 to receive the collective socializing data 154 from the system server 110 for a location based on input from the at least one user 194 for any desired location, which may or may not be related to the location of the one or more client devices 192. For example, the at least one user 194 may be planning a vacation or alternatively traveling for a work related function, and can obtain collective socializing data 154 from the system server 110 via the internet or web browser 190 for the desired location.

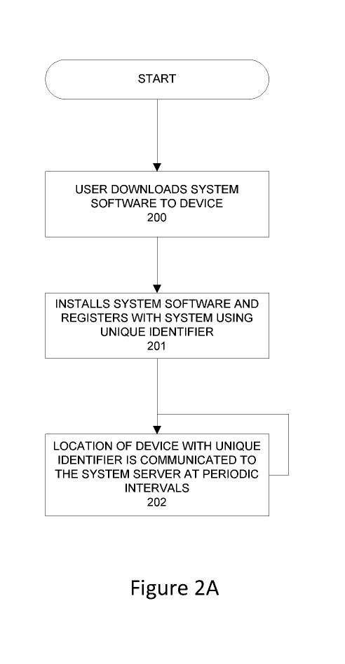

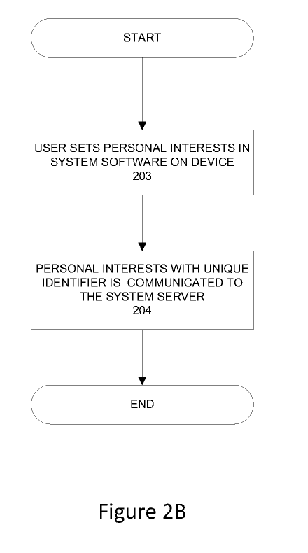

FIG. 2A is a block diagram illustrating a method of use of a system 100 for collective socializing using a mobile social network in accordance with an embodiment. As shown in FIG. 2A, in accordance with a step 200, the plurality of users 140, 142, 144, downloads the system software 114 to a mobile client device 160, 162, 164. In a step 201, the mobile client device 160 installs the system software 114 and registers the mobile client device 160, 162, 164 with the system 100 (and system provider 170) using a unique identifier 116. In a step 202, the location of the client device 160, 162, 164 having a unique identifier 116 is communicated to the system server 100 at periodic intervals.

FIG. 2B is a block diagram illustrating a method of use of a system 100 for collective socializing using a mobile network 130 in accordance with another embodiment. As shown in FIG. 2B, in accordance with a step 203, the user 140, 142, 144 sets personal interests (i.e., personal profile 154) in the system software 114 on the mobile client device 160, 162, 164. In a step 204, the personal interests (i.e., personal profile 154) with unique identifiers 116 are communicated to the system server 110.

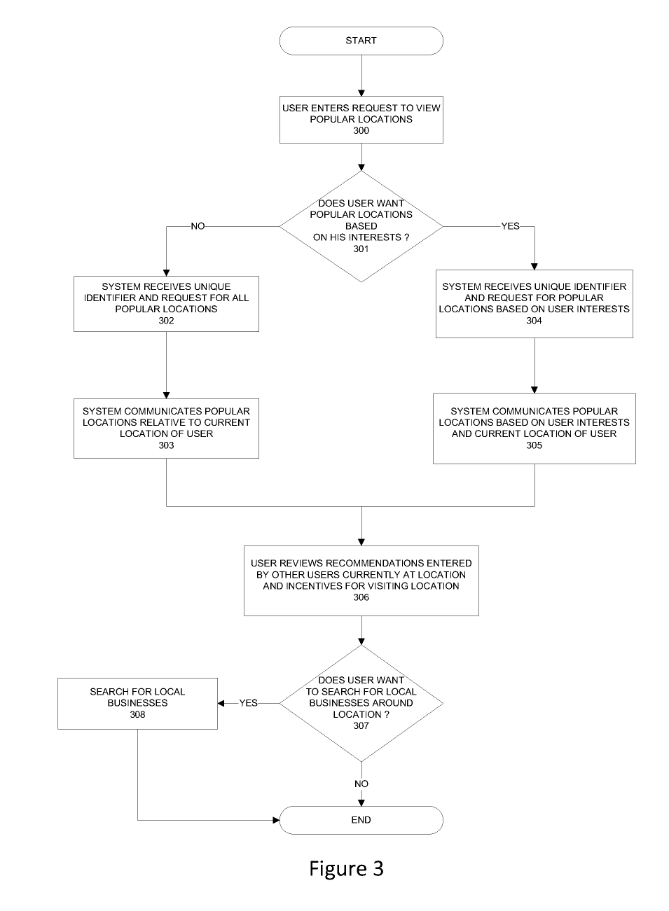

FIG. 3 is a block diagram illustrating a method of use of a system 100 for collective socializing using a mobile network in accordance with a further embodiment. As shown in FIG. 3, in a step 301, the user enters requests to view popular locations. In a step 301, the system server 100 determines whether or not the user 140, 142, 144 wants popular locations 180 based on the user's 140, 142, 144 interest. If the answer to step 301 is yes, in a step 302, the system 100 receives a unique identifier 116 and request for all popular locations 180. In a step 303, the system 100 communicates popular locations 180 relative to the current location 182 of the user 140, 142, 144. If the answer to step 301 is no, in a step 304, the system 100 receives a unique identifier 116 and a request for popular locations 180 based on the user's personal profile 154 (i.e., interests). In a step 305, the system 100 communicates popular locations 180 based on the user's personal profile 154 (i.e., interests) and the current location 182 of user 140, 142, 144 (i.e., the location of the mobile client device 160, 162, 164). In a step 306, the user 140, 142, 144 reviews recommendations entered by other users 140, 142, 144 currently at the location 180 and can be provided incentives for visiting the location 180. In a step 307, the system server 110 determines if the user 140, 142, 144 wants to search for local businesses 180 around the location 182. If the answer to step 307 is yes, in a step 308, a search for local businesses 180 is performed by the system server 110. Alternatively, if the answer to step 307 is no, no additional steps are performed and the inquiry and/or search ends.

FIG. 4A is a schematic diagram of a system 400 for collective socializing using another platform for mobile social network in accordance with an exemplary embodiment. As shown in FIG. 4A, the system 400 is comprised of a plurality of users 140, 140′, 142, 142′, 144, 144′ (or clients) and a server system 110 (or server), which communicate with one another via a mobile network or network connection 130 (FIG. 1A). The users 140, 140′, 142, 142′, 144, 144′ preferably is comprised of one or more mobile client devices 160, 160′, 162, 162′, 164, 164′ which communicates via a mobile network connection both location coordinates and personal interest to the system server 110, which includes a location database and interest of the user 140, which is stored within the system server 110.

The system server application 118 then calculates or computes an aggregation identifying FunSpots and includes an web application (e.g., Mashup) that combines collective socializing data 112 (for FunSpots) on such items as weather, reverse yellow pages, blogs, recommendations, interest filter, promotions, ads and other related interest into a single integrated tool. The collective socializing data 112 is communicate to the mobile client device 160, 160′, 162, 162′, 164, 164′ via the mobile network, network or network connection 130. The mobile client device 160, 160′, 162, 162′, 164, 164′ displays the aggregation of data from the system server 110 in the form of a local search, maps and directions, click through to maps, directions and a social network.

In accordance with an exemplary embodiment, the system 100 aggregates the current location of all the users 140, 140′, 142, 142′, 144, 144′ and identifies the locations 180 where there is a high concentration of users 140, 140′, 142, 142′, 144, 144′ and tags those locations 180 as popular locations. A user 140, 140′, 142, 142′, 144, 144′ can request to see all popular locations or only those based on his interests and/or personal profile 154. The user 140, 140′, 142, 142′, 144, 144′ can also see popular locations close to his current location 182, or can request to see the popular locations at a further location and/or destination. In accordance with an embodiment, popular locations 180 can include recommendations and reviews by other system users 140, 140′, 142, 142′, 144, 144′ currently at the location 180 or who have visited recently. In addition, the system 100 preferably provides sufficient information to the user 140, 140′, 142, 142′, 144, 144′, such that the user 140, 140′, 142, 142′, 144, 144′ can make a personal choice on where to go.

On choosing a specific location 180, the user 140, 140′, 142, 142′, 144, 144′ can invoke external services to perform a search for a particular type of business local to that location 180 and also request for directions. The user 140, 140′, 142, 142′, 144, 144′ can also bookmark the location 180 and thus be able to review future postings tagged to the location 180. Other pertinent information about the location 180 can be provided to the user 140, 140′, 142, 142′, 144, 144′, such as current weather and future weather forecasts.

Alternatively, the system 100 can also be used to explore if there are other users 140, 140′, 142, 142′, 144, 144′ at a favorite location or to find a quiet spot. For example, a user 140, 140′, 142, 142′, 144, 144′ can view locations at different distances from their current or entered location. These distances can either be numerical (i.e., 3 miles, 5 miles) or defined in terms such as within the block, a couple of blocks away, or within a city. The system 100 can also be used as a security tool that could trigger an alert if there is a mass dispersion of users from a particular location 180 within a very short time. The system 100 can be used as an alerting or alarm system in which people at a particular location 180 can be immediately informed about any development at or around that location. Triggering events can vary in use. It can be a hazard warning to initiate an evacuation or a simple marketing campaign to advertise a discount on a particular item in a store (i.e., location) 180. The system 100 can also be extended to identify traffic flow for travelers carrying their mobile device 160, 162, 164. Alternatively, zones can be created to include or omit certain locations (i.e., hotspots). In accordance with another embodiment, residential areas can be blacked out to prevent misuse of the system 100. In addition, a user 140, 140′, 142, 142′, 144, 144′ can discover a location 180 and provide the location 180 with a specific name.

In accordance with an exemplary embodiment, the system 100 can reward users for any action that can be performed in the system, including discovering and marking locations, rating and placing comments, photos and videos linked to the location and making them available to the rest of the users. In addition, the system server 110 can transmit advertisements and/or promotional materials from businesses to the client mobile devices 160, 162, 164. Alternatively, the system 100 can provide commissions for transactions and/or businesses, which engage in bids to place content in appropriate places in the system. Users 140, 140′, 142, 142′, 144, 144′ can be rewarded for any action that can be performed in the system 100, including discovering and marking locations, rating and placing comments, photos and videos linked to locations and making the action available to the rest of the users 140, 140′, 142, 142′, 144, 144′.

Businesses can also reward users 140, 140′, 142, 142′, 144, 144′ for discovering locations, marking locations, providing comments and/or favorable ratings, transmitting photos and videos or links of locations to the system server 110. In addition, businesses can place advertisements, promotions and relevant text in the context of the identified locations, which can be transmitted to the users 140, 140′, 142, 142′, 144, 144′ with the collective socializing data for a location. Commission can also be applied on these transactions and businesses can be engaged to place bids on the transmission or delivery of collective socializing data 112 in appropriate places in the system 100. Identified Hot Spots can also be listed or displayed in a map view. In addition, locations can be shared in social networking sites and can also enhance the Local web search—aka search by location.

FIG. 4B is a schematic diagram of a system 100 for collective socializing using a mobile social network in accordance with another embodiment. In accordance with an exemplary embodiment, the gathering of the location 182 (or locals) of the mobile client devices 160, 162, 164 can be from an individual program on the mobile client devices 160, 162, 164 or aggregated from service providers 196, such as T-Mobile®, AT&T®, Verizon®, Sprint® or Nextel®, which provides the location coordinates to the system server 110 via any suitable method. For example, the location of a mobile client device 160, 162, 164 in the form of a cellular phone can be obtained by triangulating the cell phone towers in which the mobile client device 160, 162, 164 is using.

In a series of exemplary embodiments, the system 100 can include:

Scenario 1:

John is leaving work and he has an hour to spend before heading to the airport. He starts the program on his phone or mobile client device 160 where he already has set his interests to include baseball. He requests the system 100 to find popular locations within five miles of the airport. He is presented with two popular locations, a cafe and a sports bar. His impulse is to get directions to the sports bar but on applying his interest filter, he finds out that at the cafe, there are more users who are interested in baseball than at the sports bar. He decides to go to the cafe and requests directions from the system 100.

Scenario 2:

Cathy has taken the train to New York City for a conference. She has the afternoon to explore the city. She requests the program or system 100 to find popular locations within blocks of the train station. A popular location is Central Park and reviewing the comments from other users, she discovers that the Philharmonic is currently having a free concert there. She decides to spend a few hours at the concert before heading for the conference.

Scenario 3:

Kevin is new to San Francisco and would like to make new friends. He requests the program or system 100 to identify some popular locations near his apartment. He is surprised to find out that just a couple of blocks away there is a popular location, a bar. He wants to have pizza for dinner. He searches for pizza places close to the suggested popular location. He is able to enjoy his pizza and also hang out to make new friends.

Scenario 4:

Tim frequently plays basketball at a court near his office and has bookmarked the court as a favorite location. On a Tuesday afternoon, he is alerted to a message posted for the basketball court requesting for more players to show. He observes that there are currently five people at the location and heads over for a quick game.

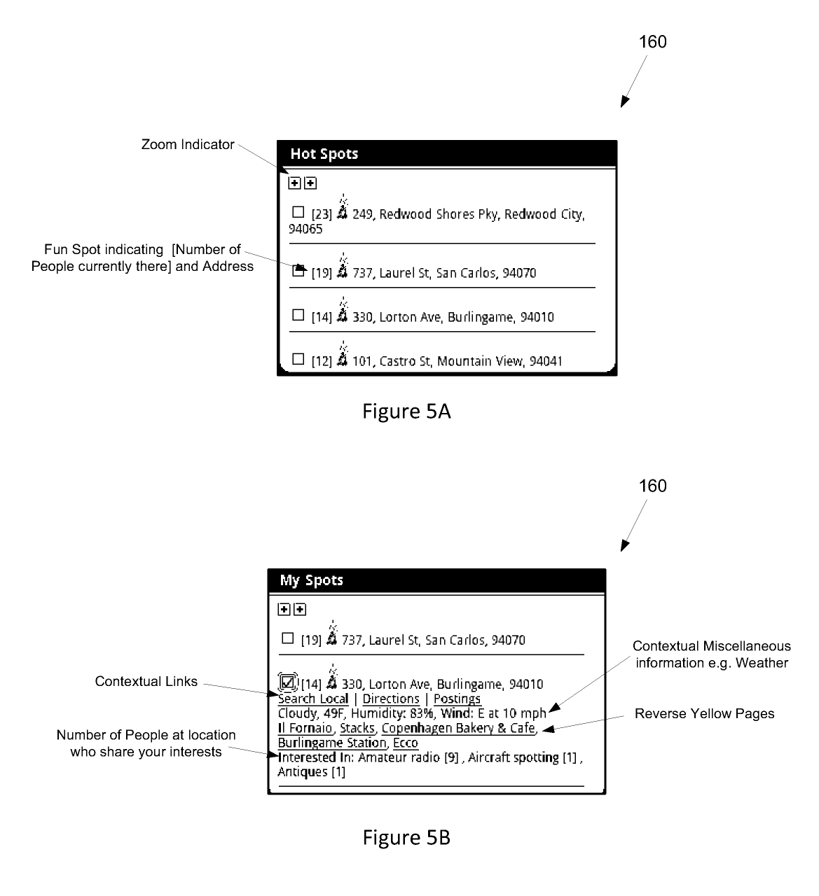

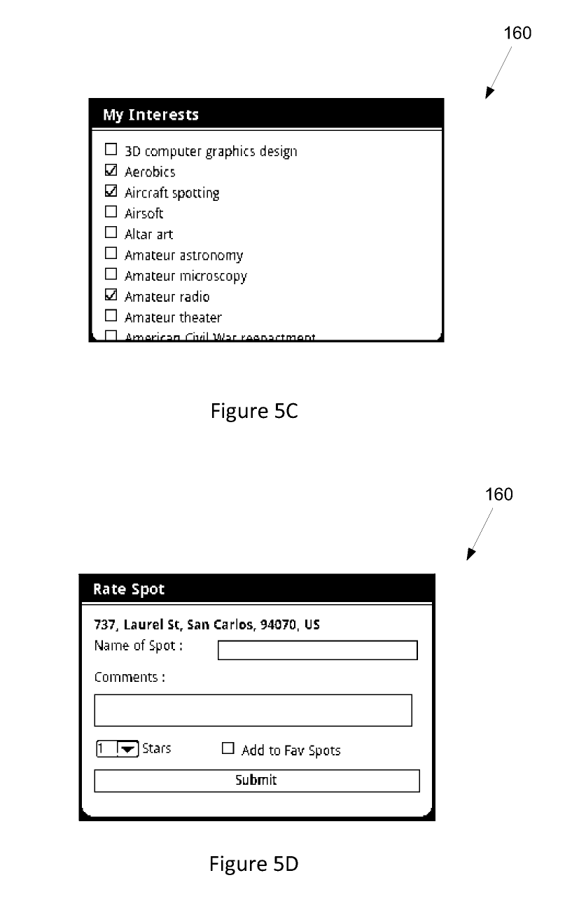

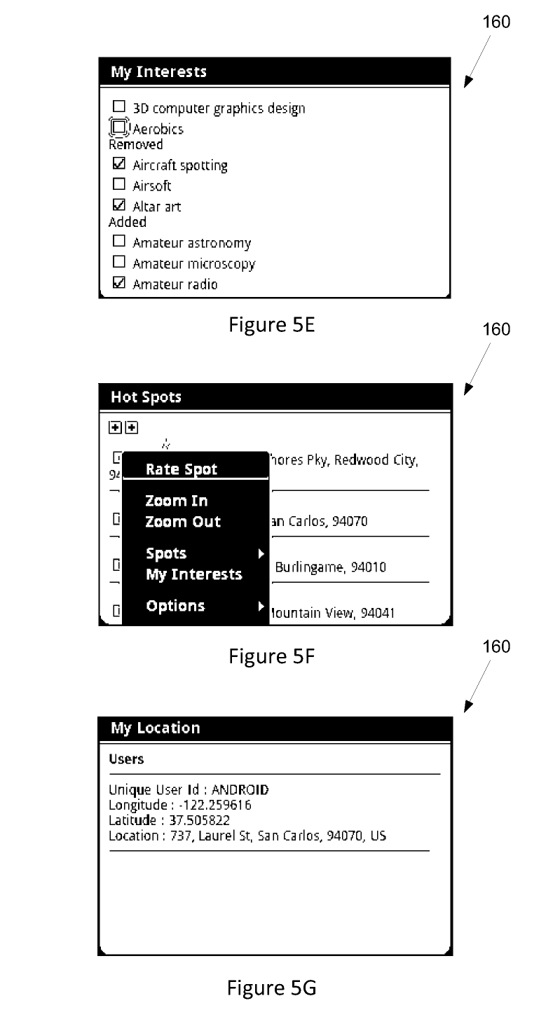

FIGS. 5A-5G are screens shots or displays of a mobile client device 160 in the form of a personal digital assistant (PDA) showing the use of a system 100 and/or method for collective socializing using a mobile social network in accordance with an exemplary embodiment. It can be appreciated that in accordance with an exemplary embodiment, the mobile client device 160, 162, 164 employs touch screen technology.

For example, as shown in FIG. 5A, the display (or graphical user interface (GUI)) of the mobile client device 160 showing Hot Spots and having a zoom indicator, and a Fun Spot indicator, which can include Number of people currently at a specific location and Address. FIG. 5B shows the mobile client device 160 showing a plurality of Hot Spots, which are of interest to the user 140 (i.e., My Spots). As shown in FIG. 5B, the display includes Contextual links, a Fun Spot indictor (including number of people currently there) and Address, Number of people at the location who share a similar or common interest as the user thereof, Contextual miscellaneous information, (e.g., weather), and reverse yellow pages.

FIG. 5C shows the mobile client device 160 showing the display with a list of interest, wherein the user 140 can identify those interests, which are relevant or of interest to the user 140. FIG. 5D shows the display, wherein the user 140 can rate (i.e., Rate Spot) a specific business, or location, such as a park or event (i.e., Fun Spot). FIG. 5E shows the mobile client device 160 showing the display with a list of interest, wherein the user 140 can identify those interests (i.e., My Interests), which are relevant or of interest to the user 140, and wherein the user 140 can add or remove specific interest via the mobile client device 160. The system 100 also preferably has the ability to add additional items or interests based on an analysis or review of the personal profiles of the users 140 and their related interests. As shown in FIG. 5F, the display of the mobile client device 160 includes a menu (preferably a pull down), which can include categories such as Rate Spot, Hot Spots, My Hot Spots, Favorite Spots (Fav Spots), Map View, My Interest, Activate, My Device ID, and My Location. The display of the mobile client device 160 can also show related information on Hot Spots, such as the weather including general conditions, such as sunny, rainy, cloudy, Temperature, humidity, and wind conditions.

It can be appreciated that the software system as shown in FIG. 5G conveys the mobile client devices 160 location in longitude, latitude and common name of the location for each unique user via an Id. (identifier), which the user 140 can see on the display upon request (i.e., My Location).

In an exemplary embodiment, a computer program which implements all or parts of the processing described herein through the use of a system 100 as illustrated in FIGS. 1A-5G can take the form of a computer program product residing on a computer usable or computer readable medium. Such a computer program can be an entire application to perform all of the tasks necessary to carry out the invention, or it can be a macro or plug-in which works with an existing general-purpose application such as a spreadsheet program. Note that the “medium” may also be a stream of information being retrieved when a processing platform or execution system downloads the computer program instructions through the Internet or any other type of network. Computer program instructions, which implement the invention, can reside on or in any medium that can contain, store, communicate, propagate or transport the program for use by or in connection with any instruction execution system, apparatus, or device. Such a medium may be, for example, but is not limited to, an electronic, magnetic, optical, electromagnetic, or semiconductor system, apparatus, device, or network. Note that the computer usable or computer readable medium could even be paper or another suitable medium upon which the program is printed, as the program can then be electronically captured from the paper and then compiled, interpreted, or otherwise processed in a suitable manner.

While the invention has been described with reference to specific embodiments, this description is merely representative of the invention and is not to be construed as limiting the invention. Various modifications and applications may occur to those skilled in the art without departing from the true spirit and scope of the invention as defined by the appended claims.

What is claimed is:

1. A method for collective socializing using a mobile social network comprising:
obtaining collective socializing data on at least one location; and
transmitting the collective socializing data upon request of at least one user.

2. The method of claim 1, wherein the step of obtaining collective socializing data on at least one location further comprises:
storing the collective socializing data on the at least one location on a system server;
obtaining additional collective socializing data from a plurality of users on the at least one location; and
combining the additional collective socializing data with the collective socializing data on the system server for transmittal to the at least one user upon request.

3. The method of claim 1, further comprising providing the collective socializing data to the at least one user based on a personal profile.

4. The method of claim 3, further comprising identifying the at least one user with a unique identifier, wherein the unique identifiers for the at least one user identifies the user's personal profile.

5. The method of claim 1, further comprising transmitting the collective socializing data to the at least one user via a mobile client device.

6. The method of claim 5, wherein the collective socializing data is transmitted to the mobile client device based on a location of the mobile client device.

7. The method of claim 1, further comprising obtaining additional collective socializing data from the at least one user.

8. The method of claim 5, further comprising periodically transmitting a location of the mobile client device to a system server.

9. The method of claim 7, further comprising encrypting and decrypting the additional collective socializing data transmitted to and from the mobile client device.

10. The method of claim 3, further comprising filtering the personal profile of the at least one user into groups or subgroups of users having similar personal profiles.

11. The method of claim 5, further comprising gathering the location of the mobile client device from an individual program on the mobile client device or aggregated from service providers.

12. The method of claim 1, further comprising identifying locations having a high concentration of users.

13. The method of claim 1, further comprising providing incentives to the at least one user to visit location by providing discounts and promotion codes for special offers.

14. The method of claim 1, further comprising transmitting the collective socializing data to the at least one user via a web browser.

15. The method of claim 1, further comprising using the system as a security tool to trigger an alert if there is a mass dispersion of users from a particular location that occurs within a short period of time.

16. The method of claim 1, further comprising rewarding the at least one user for any action that can be performed in the system, including discovering and marking locations, rating and placing comments, photos and videos linked to the location and making them available to the rest of the users.

17. The method of claim 5, further comprising placing advertisements and promotional materials from businesses on the transmission from the server system to the mobile client device.

18. A method for collective socializing using a mobile social network comprising:
storing collective socializing data for a plurality of locations on a server system;
obtaining additional collective socializing data from a plurality of users, wherein the additional collective socializing data further comprises transmitting a location of the at least one mobile client device to the system server;
identifying each of the plurality of users with a unique identifier, wherein the unique identifiers for each of the plurality of users identifies the user's personal profile;
combining the addition collective socializing data with the collective socializing data on the system server;
obtaining a request from a user for collective socializing data from the server system;
providing the collective socializing data to the user based on the user's personal profile; and
transmitting collective socializing data to a user via a mobile client device.

19. A system for collective socializing using a mobile social network comprising:
a system server for managing a collective socializing application for a plurality of locations; and
one or more mobile client devices, which receive collective socializing application from the system server for a location based on the location of the mobile client device via a network.

20. The system of claim 19, wherein each of the one or more mobile client devices has client software, which registers at least one user with the server system using a unique identifier, and wherein the unique identifier for each of the users identifies the user's personal profile.

21. The system of claim 19, further comprising a security server for encrypting and decrypting a location and/or personal profile from each of the one or more mobile client devices.

22. The system of claim 19, further comprising a database associated with the system server, and wherein each of the user's personal profiles are transmitted and stored in the database.

23. The system of claim 19, further comprising an interest filter, which filters personal profiles of each of the users into similar interests and provides the users with locations of others with similar personal profiles.
